(19) United States
(12) Patent Application Publication
(10) Pub. No.: US 2024/0141146 A1
(43) Pub. Date: May 2, 2024

(54) BIODEGRADABLE TIRE AND TIRE COMPOSITION

(71) Applicants: Samuel H. Creelan, New York, NY (US); Duke E. Garschina, Center Point, TX (US); Nathan W. Khuu, West Simsbury, CT (US); Sachin K. Shetty, Dallas, TX (US)

(72) Inventors: Samuel H. Creelan, New York, NY (US); Duke E. Garschina, Center Point, TX (US); Nathan W. Khuu, West Simsbury, CT (US); Sachin K. Shetty, Dallas, TX (US)

(21) Appl. No.: 18/494,469

(22) Filed: Oct. 25, 2023

Related U.S. Application Data
(60) Provisional application No. 63/381,024, filed on Oct. 26, 2022.

(51) Int. Cl. C08L 7/00; B60C 7/00; C08J 9/00; C08K 3/22; C08K 5/13; C08K 5/18

(52) U.S. Cl. CPC C08L 7/00; B60C 7/00; C08J 9/0023; C08J 9/0028; C08J 9/0061; C08J 9/0066; C08K 3/22; C08K 5/13; C08K 5/18; B60C 2001/0091; C08J 2205/044; C08J 2205/05; C08J 2307/00; C08J 2489/00; C08J 2497/02; C08K 2003/2206; C08K 2003/2296; C08L 2201/08; C08L 2203/14; C08L 2205/03

(57) ABSTRACT

A biodegradable tire includes an elastomeric matrix and a shape memory alloy scaffold integral with the matrix. The elastomeric matrix includes (by weight of the matrix) a flax seed material derived from 14% to 19%, a guayule-derived natural rubber from 55% to 65%, a metal oxide from 12% to 15%, a carbon-based filler from 9% to 12%, and one or both of an antioxidant and an antiozonant, each from 1.8% to 3.1%. Further, the tire is airless. In addition, the shape memory alloy scaffold comprises a Ni—Ti shape memory alloy, a Cu—Zn shape memory alloy, or a combination thereof.

### CROSS-REFERENCE TO RELATED APPLICATIONS

This application claims the benefit of priority under 35 U.S.C. § 119 of U.S. Provisional Application No. 63/381,024, filed on Oct. 26, 2022, and entitled TIRE COMPOSITION AND ASSEMBLY, the entire contents of which are incorporated herein by reference.

### TECHNOLOGICAL FIELD

The present disclosure generally relates to a biodegradable tire and tire composition. More specifically, the present disclosure relates to a biodegradable tire including an elastomeric matrix and a shape memory alloy scaffold.

### BACKGROUND

The compound of a tire defines its handling, durability, and performance characteristics. Rubber is the primary raw material used to produce conventional automotive tires. Rubber can be either natural or synthetic. To produce the synthetic rubber used in conventional automotive tires, it takes approximately seven barrels of oil and extensive refining. This process is thought to be unsustainable from an environmental standpoint. While “natural rubber,” commonly produced by the hevea tree (Hevea brasiliensis), grows naturally, this tree only grows in a narrow equatorial band and requires nearly ten years to cultivate. As the demand for natural rubber is the highest it has ever been, alternatives to “hevea rubber” are valuable. Guayule (Parthenium argentatum) is a small shrub-like plant that grows in arid swathes of Mexico and the Southwest. Unlike the hevea tree, guayule shrubs have much shorter life cycles and require much less water and support to grow. Additionally, guayule rubber (e.g., natural rubber produced from guayule shrubs) has comparable durability to hevea rubber as well as a large capacity for heat-dissipation.

In addition to the unsustainable production methods of conventional automotive tires, these tires are pneumatic and require inflation to provide adequate performance. Since pneumatic tires are filled with air, they are susceptible to deflation (e.g., a flat tire) and heat generation during use. In order to create an airless tire with desirable performance, the structure of the tire needs to support sufficient lateral and vertical compliance under the load of a vehicle.

Accordingly, there is a need for biodegradable tire compositions that can be sourced and produced with environmentally sustainable processes. Moreover, there is a need for biodegradable tires, which are also non-pneumatic, that overcome both of the sustainability and durability issues of conventional automotive tires.

### SUMMARY OF THE DISCLOSURE

According to one aspect, a biodegradable tire composition includes (by weight of the tire composition) a flax seed material from 14% to 19%, a guayule-derived natural rubber derived from 55% to 65%, a metal oxide from 12% to 15%, a carbon-based filler from 9% to 12%, and one or both of an antioxidant and an antiozonant, each from 1.8% to 3.1%.

According to another aspect, a biodegradable tire includes an elastomeric matrix and a shape memory alloy scaffold integral with the elastomeric matrix. The elastomeric matrix includes (by weight of the elastomeric matrix) a flax seed material from 14% to 19%, a guayule-derived natural rubber from 55% to 65%, a metal oxide from 12% to 15%, a carbon-based filler from 9% to 12%, and one or both of an antioxidant and an antiozonant, each from 1.8% to 3.1%. Further, the tire is airless. In addition, the shape memory alloy scaffold comprises a Ni—Ti shape memory alloy, a Cu—Zn shape memory alloy, or a combination thereof.

According to yet another aspect, a biodegradable tire includes an elastomeric matrix and a shape memory alloy scaffold integral with the elastomeric matrix. The elastomeric matrix includes closed hexagonally-shaped cells. The shape memory alloy scaffold includes a helical structure. Further, the elastomeric matrix comprises (by weight of the elastomeric matrix) a flax seed material from 14% to 19%, a guayule-derived natural rubber from 55% to 65%, a metal oxide from 12% to 15%, a carbon-based filler from 9% to 12%, and one or both of an antioxidant and an antiozonant, each from 1.8% to 3.1%. Further, the tire is airless. In addition, the shape memory alloy scaffold comprises a Ni—Ti shape memory alloy, a Cu—Zn shape memory alloy, or a combination thereof.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

FIG. 1 is an elevational, cutaway view of a biodegradable tire in accordance with one aspect of the disclosure;

FIG. 2 is a cross-sectional view of a portion of the tire of FIG. 1 taken through line II-II;

FIG. 3 is a perspective view of a shape memory alloy scaffold in accordance with one aspect of the disclosure; and

FIG. 4 is a schematic view of an elastomeric matrix in accordance with one aspect of the disclosure.

### DETAILED DESCRIPTION

The present illustrated embodiments reside primarily in combinations of method steps and apparatus components related to a biodegradable tire. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

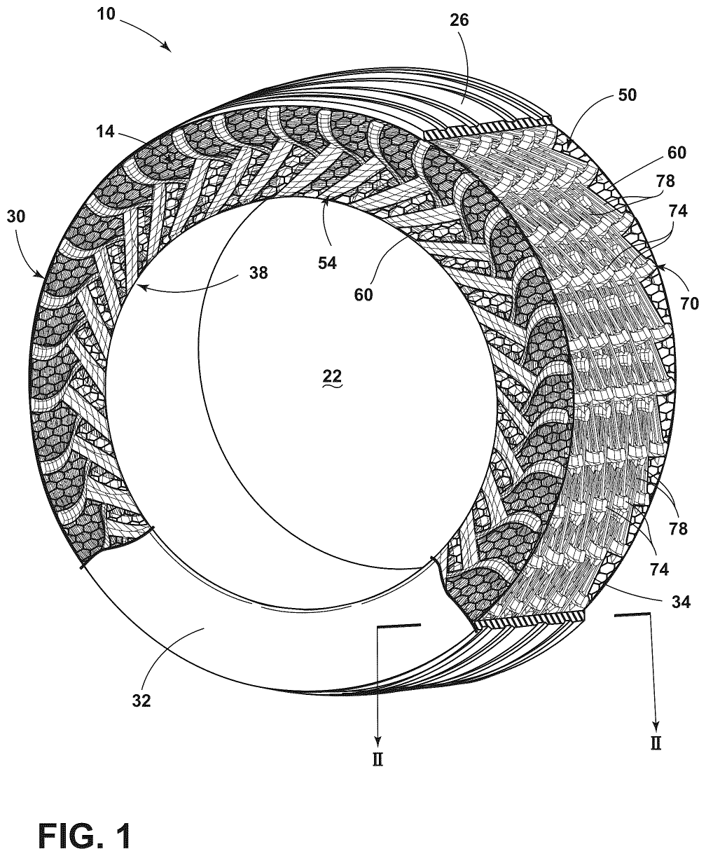

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

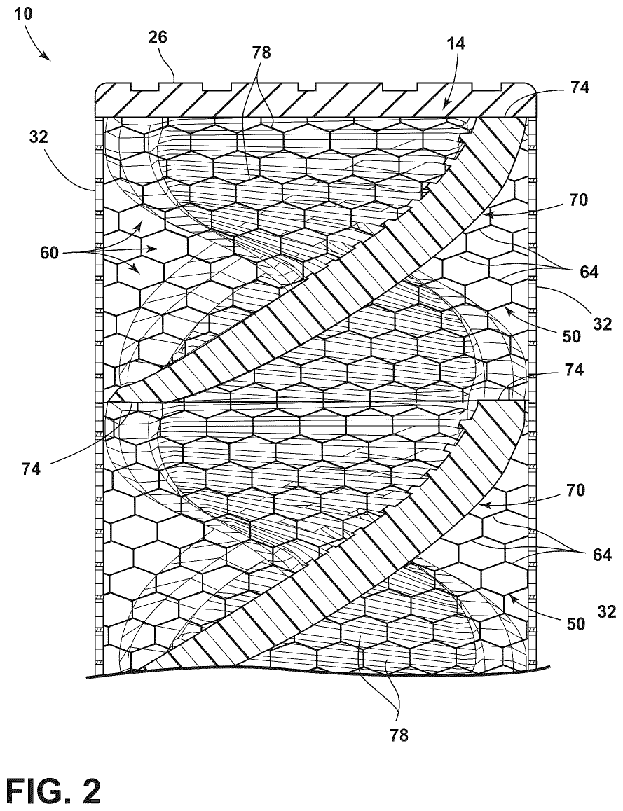

Referring to FIGS. 1 and 2, reference numeral 10 generally designates a biodegradable

tire made using a biodegradable tire composition 14. In some examples, the biodegradable tire composition 14 includes (by weight of the tire composition) a flax seed material derived from flax seed from 14% to 19%, a natural rubber derived from guayule from 55% to 65%, a metal oxide from 12% to 15%, a carbon-based filler from 9% to 12%, and one or both of an antioxidant and an antiozonant from 1.8% to 3.1% in total.

Still referring to FIGS. 1 and 2, the biodegradable tire 10 includes an annular configuration, which is suitable for mounting to a rim of a wheel and for making continuous contact with a surface (e.g., a road) during rolling (e.g., propelling an automobile). A portion of the biodegradable tire 10 that is in contact with the surface at a given time may be referred to as a “contact patch.” In some aspects, the biodegradable tire 10 defines a wheel opening 22 in a center thereof, the wheel opening 22 sized to receive and couple the wheel. Further, the biodegradable tire 10 includes a width dimensioned to enclose and surround the rim of the wheel such that the rim does not make contact with the surface during use.

The biodegradable tire 10 includes tread 26 on a perimeter surface, or an outer annular surface 30, thereof. The tread 26 can include a depth within a range of 12-14 millimeters (mm) to account for the above average lifespan of the biodegradable tire 10. However, it is within aspects of the disclosure for the tread 26 to include any suitable configuration (e.g., depth, shape, density). Further, the biodegradable tire 10 can include one or more sidewalls 32. The tread 26 and/or the sidewalls 32 can be formed of the biodegradable tire composition 14. In specific examples, an elasticity of the tread 26 is approximately 47% by ISO 4662/2009 standards. The sidewall 32 can include a section height (e.g., height from the outer annular surface 30 toward an inner annular surface 38) in a range of approximately 90-110 mm. Specifically, the sidewall 32 may include a section height of approximately 99 mm.

While the biodegradable tire 10 shown in the corresponding drawings is described for use with an automotive vehicle, the biodegradable tire 10 and its corresponding components are not limited to such applications. Rather, the biodegradable tire 10 and its corresponding components can include any suitable dimensions such that the biodegradable tire 10 can be utilized in a variety of vehicles having different tire size requirements. In some examples, the biodegradable tire 10 is utilized in a wheeled motor vehicle, such as a sedan, a sport utility vehicle, a truck, a van, a crossover, an all-terrain vehicle, a dirt bike, and the like. However, the biodegradable tire 10 may be utilized in other applications such as in planes, bicycles, etc., without departing from the scope of the present disclosure.

An interior 34 of the biodegradable tire 10 may be defined as an area extending from the outer annular surface 30 toward the inner annular surface 38. In some examples, the inner annular surface 38 can define the wheel opening 22 such that the inner annular surface 38 contacts the rim of the wheel when the biodegradable tire 10 is mounted to said wheel. The biodegradable tire 10 of the present disclosure includes structures specifically configured to impart advantageous performance characteristics, which can be included within the interior 34. As illustrated in FIG. 1, the biodegradable tire 10 includes an elastomeric matrix 50 and a shape memory alloy scaffold (SMAS) 54 within the interior 34.

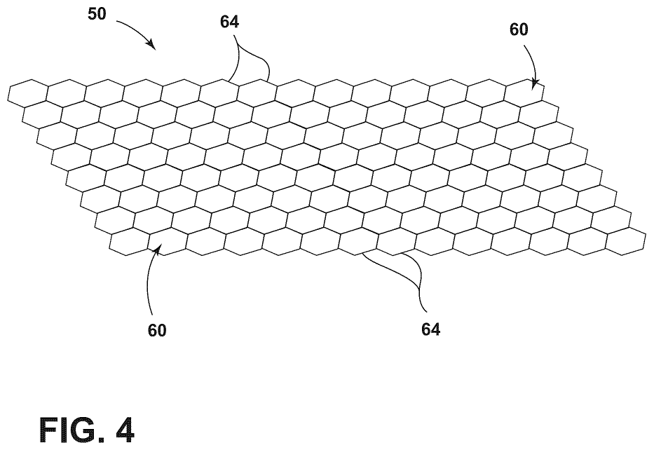

Referring now to FIGS. 1-2 and 4, the elastomeric matrix 50 provides a supportive structure for the biodegradable tire 10 and is made of the biodegradable tire composition 14. In some aspects, the elastomeric matrix 50 is similar to a honeycomb structure, which mimics the effect of a cushion of air in a pneumatic tire. The elastomeric matrix 50 can isolate the “cushioning” effect to an area adjacent the contact patch. Therefore, under hard acceleration or braking, the elastomeric matrix 50 drastically reduces vibration, which continues to be an issue for modern road tires. As illustrated, the elastomeric matrix 50 includes a plurality of polygonal-shaped cells 60. The cells 60 are closed and distributed throughout the interior 34 of the biodegradable tire 10 in a three-dimensional array. Therefore, the cells 60 can be hollow and include an interior space therein.

Accordingly, the biodegradable tire 10 can include a density of approximately from 5,000 to 15,000, 7,500 to 12,500, or 9,500 to 11,500 individual polygonal-shaped cells 60. Further, the biodegradable tire 10 can include any quantities or subranges within the foregoing ranges or any number of cells 60 required to produce a proportional density (e.g., based tire size). In this way, the biodegradable tire 10 can include any numbers of cells 60 within the foregoing ranges. For example and in one aspect, the biodegradable tire 10 includes a density of approximately 10,500 individual polygonal-shaped cells 60. Again, the biodegradable tire 10 may include any suitable number or range of the polygonal-shaped cells 60 to adjust for a desired proportion and density of the cells 60, which may depend on the application or size of the biodegradable tire 10 (e.g., automotive, off-road, plane).

The polygonal-shaped cells 60 may be any suitable geometric shape, such as pentagons, hexagons, heptagons, octagons, nonagons, decagons and the like, and can include any number of corresponding walls 64. In one specific aspect, the cells 60 are hexagonal such that cells 60 are formed of six adjoining walls 64. Each wall 64 may include a width of approximately 1.0 mm such that a perimeter length of the cells 60 is approximately 6.0 mm. The walls 64 of each cell 60 can have a thickness in a range of approximately 250 microns (μm) to 350 μm. A preferred cell 60 thickness may be approximately 300 μm. However, it is within the scope of the disclosure for the cells 60 and corresponding walls 64 to include any suitable dimension/size. In this way, a perimeter length of the cells 60 can be in a range of approximately 4.0-8.0 mm. The dimensions of the cells 60 are consistent, having tight tolerances, throughout the biodegradable tire 10 to maintain linear compound-based compression. Moreover, it is contemplated that certain polygonal shapes, such as the illustrated hexagonally-shaped cells 60, in combination with cell size, assist in generating an optimal density of the elastomeric matrix 50 and in conjunction with the shape of the SMAS 54 generate advantageous performance characteristics for the biodegradable tire 10. The tensile strength of the biodegradable tire composition 14 according to ISO 37/2012 is approximately 4.5 N/mm².

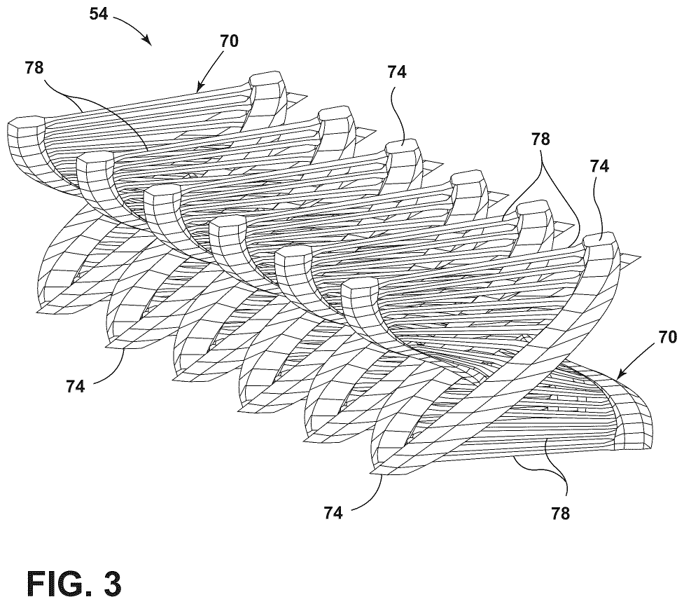

Referring now to FIGS. 1-3, the shape memory alloy scaffold (SMAS) 54 also provides support for the biodegradable tire 10. It is contemplated that the SMAS 54 is integral with (e.g., intersects) the elastomeric matrix 50 such that the SMAS 54 passes through the elastomeric matrix 50. The SMAS 54 is shown as integral with the elastomeric matrix 50 in FIGS. 1 and 2. However, it is within the scope of the disclosure for the SMAS 54 and the elastomeric matrix 50 to be separate such that these structures are not connected. In specific implementations, the SMAS 54 consists of helical structures 70 spaced in a radial direction around the interior 34 of the biodegradable tire 10. The helical structures 70 may include a pair of twisted strands 74 that are banded together by a plurality of lateral, equidistantly spaced rungs 78. The SMAS 54 is designed to support the contact patch of the tire 10 under a load. In one aspect, the twisted strands 74 extend from the outer annular surface 30 to the inner annular surface 38. The double helix configuration of the SMAS 54 performs similar to a coil spring, while requiring much less material, and, therefore, weight, to construct. The geometry of the helical structures 70 can vary such that the diameter, number of turns, and pitch of the twisted strands 74 can be adjusted for desired performance and by tire size. In some implementations, the helical structures 70 can have conformational parameters which are proportional to the parameters of a DNA helix, such as A-DNA, B-DNA, and Z-DNA helices.

The SMAS 54 structures are reinforced with, or made substantially of, a shape memory alloy material. Unlike typical metallic materials that can be permanently deformed once exposed to deformation stress outside of their elastic range, the shape memory alloy material is “superelastic.” In this way, the SMAS 54 can deform and return to its initial shape when the deforming force is removed. Further, shape memory alloy materials, as used in the SMAS 54, have an advantageous mechanical property dependency on temperature. Certain compositions of the shape memory alloy materials can be selected to tailor the SMAS 54 response to temperature changes experienced by the tire 10 from friction associated with movement. In one aspect, the shape memory alloy material becomes rigid at relatively high temperatures. As a result, the biodegradable tire 10 can bend and rebound effectively in slow, off-road situations (e.g., rolling on various terrains) and also perform effectively when the biodegradable tire 10 is heated due to higher speeds and contact with pavement (e.g., rolling on a road). In some examples, the SMAS 54 structures are woven and disposed below the tread 26 to enable direct transfer of heat from the tread 26 to the SMAS 54.

Table 1 illustrates contemplated ranges for exemplary components used in the shape memory alloy scaffold material. However, the shape memory alloy scaffold material can include any suitable alloy(s) having shape memory characteristics. In some examples, the shape memory alloy scaffold material includes one or both of a Ni—Ti alloy and Cu—Zn alloy.

TABLE 1

| | Amount (atomic weight percent) | |
|---|---|---|
| Compound | Ni—Ti alloy | Cu—Zn alloy |
| Nickel (Ni) | 55-60% or 57.5-58% | ~0% |
| Titanium (Ti) | 40-45% or 42-42.5% | ~0% |
| Zinc (Zn) | ~0% | 38.5-42.0% or 40-40.5% |
| Copper (Cu) | ~0% | 58-61.5% or 59.5-60% |

In some aspects of the present disclosure, a method of producing the biodegradable tire 10 includes injection molding the elastomeric matrix 50 around the SMAS 54, thereby forming the overall support structure of the biodegradable tire 10. For example, the SMAS 54 may be positioned within a mold that forms components of the tire 10, including the elastomeric matrix 50. The mold can also include shapes complementary to the tread 26 and/or sidewalls 32 to form these components during injection molding. Then, a solution including the biodegradable tire composition 14 is injected under pressure into the mold, thereby forming the elastomeric matrix 50 around the SMAS 54. Optionally, the SMAS 54 can be made using vacuum-arc or induction melting to preserve purity and cast into the helical shapes of the SMAS 54.

A method of producing the biodegradable tire composition 14 can include forming a rubber mixture of guayule rubber, water (e.g., distilled water, deionized water), one or both of an antioxidant and an antiozonant, and a flax seed material derived from flax seed (e.g., flaxseed oil). Water, which may be distilled water, is included in the initial rubber mixture to attain a desirable viscosity for injection molding. However, a final composition of the formed elastomeric matrix 50 includes a negligible amount of water. Next, the method can include cross-linking a carbon-based filler (e.g., recycled sawdust) with the rubber mixture. In some examples, cross-linking of the carbon-based filler and the rubber mixture is accomplished using electron beam irradiation at an intensity of approximately 300 kilograys (kGY), but is not limited to such.

Table 2 illustrates contemplated ranges for the components of the initial rubber mixture (e.g., prior to injection molding) and the biodegradable tire composition 14 (e.g., after injection molding) for the biodegradable tire 10.

The initial rubber mixture for producing the biodegradable tire composition 14 can include guayule polyterpene (by weight of the initial mixture) in amounts from approximately 20% to 60%, 30% to 50%, or 40% to 50%. Further, the initial rubber mixture for producing the biodegradable tire composition 14 can include any quantities or subranges of guayule polyterpene within the foregoing ranges. For example, and in one aspect, the biodegradable tire composition 14 includes approximately 48 wt. % guayule polyterpene. In some examples, guayule natural rubber includes dried and coagulated guayule polyterpene, but is not limited to such, and may be any suitable form of postharvest processed guayule rubber providing the compound cis-1,4-polyisoprene.

The initial rubber mixture for producing the biodegradable tire composition 14 can include flax seed extract (by weight of the initial mixture) in amounts from approximately 5.0% to 20%, 8.0% to 15%, or 10% to 13%. Further, the initial rubber mixture for producing the biodegradable tire composition 14 can include any quantities or subranges of flax seed extract within the foregoing ranges. For example and in one aspect, the biodegradable tire composition 14 includes approximately 12 wt. % flax seed extract. The flax seed material includes a flax seed extract, such as high linolenic flaxseed oil. However, the flax seed material is not limited to such and may be any suitable extract from seeds of Linum usitatissimum. In some aspects, the flax seed material mimics the physical characteristics of silica, which is traditionally used to increase rigidity in tire compositions.

The initial rubber mixture for producing the biodegradable tire composition 14 can include distilled water (by weight of the initial mixture) in amounts from approximately 5.0% to 20%, 8.0% to 15%, or 10% to 13%. Further, the initial rubber mixture for producing the biodegradable tire composition 14 can include any quantities or subranges of distilled water within the foregoing ranges. For example and in one aspect, the biodegradable tire composition 14 includes approximately 20 wt. % distilled water.

The initial rubber mixture for producing the biodegradable tire composition 14 can include zinc oxide (by weight of the initial mixture) in amounts from approximately 5.0% to 20%, 7.0% to 15%, or 9.0% to 11%. Further, the initial rubber mixture for producing the biodegradable tire composition 14 can include any quantities or subranges of zinc oxide within the foregoing ranges. For example and in one aspect, the biodegradable tire composition 14 includes approximately 10 wt. % zinc oxide. The biodegradable tire composition 14 can include the metal oxide to promote cross-linking for increasing durability of the biodegradable tire 10 (e.g., vulcanization). Some examples of suitable metal oxides include, but are not limited to, zinc oxide (ZnO) or calcium oxide (CaO). Further, it is within aspects of the disclosure for the biodegradable tire composition 14 to include additional or alternative compounds to promote cross-linking, or vulcanize the rubber, such as sulfur and the like. For example, the method of producing the biodegradable tire composition 14 can include a cold vulcanization step using sulfur dioxide and/or an efficient vulcanization step using polymeric sulfurs (e.g., a polymer having disulfur groups).

The initial rubber mixture for producing the biodegradable tire composition 14 can include an antioxidant/antiozonant (by weight of the initial mixture) in amounts from approximately 0.5% to 4.0%, 1.0% to 3.0%, or 1.5% to 2.5%. Further, the initial rubber mixture for producing the biodegradable tire composition 14 can include any quantities or subranges of an antioxidant/antiozonant within the foregoing ranges. For example and in one aspect, the biodegradable tire composition 14 includes approximately 1.5 wt. % of one or both of an antioxidant/antiozonant. Some examples of suitable antiozonants include a phenylenediamine additive (e.g., 6PPD and/or RU-997), but are not limited to such. Some examples of suitable antioxidants include 6PPD and/or a phenolic additive, such as a propionate (e.g., Irganox® 1010), but are not limited to such. It is to be noted that in the event that a phenolic is used for the biodegradable tire composition 14, a preferred range of this component may be in a range of approximately 2.0-2.5 wt. %. In some implementations, the antiozonant (e.g., a compound that prevents degradation of the rubber caused by ozone) may protect the biodegradable tire composition 14 against degradation due to both ozone and oxygen exposure. The antioxidant can protect the biodegradable tire composition 14 against degradation due to oxygen exposure. However, it may be beneficial for the biodegradable tire composition 14 to include at least one of each of an antiozonant and an antioxidant as the combination of these two compounds can have a synergistic effect for increased protection against oxygen and ozone molecules in the atmosphere.

The initial rubber mixture for producing the biodegradable tire composition 14 can include reinforcing agents, such as a sawdust mixture, (by weight of the initial mixture) in amounts from approximately 4% to 15%, 6% to 12%, or 8% to 10%. Further, the initial rubber mixture for producing the biodegradable tire composition 14 can include any quantities or subranges of reinforcing agents within the foregoing ranges. For example and in one aspect, the biodegradable tire composition 14 includes approximately 8.5 wt. % of reinforcing agents, such as a sawdust mixture. The carbon-based filler can function as a reinforcing agent. One example of the reinforcing agent filler includes the sawdust mixture, but is not limited to such (e.g., grains). The sawdust mixture can be recycled and/or sourced from a single plant (e.g., beech sawdust).

TABLE 2

| | Approximate Amount (percent by weight of the | | | |
|---|---|---|---|---|
| | biodegradable tire composition) | | | |
| | | | | Preferred |
| | | Preferred | Range of final | range of final |
| | Range of initial | range of initial | elastomeric | elastomeric |
| Compound | rubber mixture | rubber mixture | matrix | matrix |
| guayule | 47-52% | 47-49% | 55-65% | 55-61% |
| natural rubber | | | | |
| flax seed | 12-15% | 12-13% | 14-19% | 14-16.3% |
| material | | | | |
| metal oxide | 10-12% | 10-11% | 12-15% | 12-14% |
| carbon-based | 8-9.5% | 8.5-9.0% | 9-12% | 10-11% |
| filler | | | | |
| antioxidant | 1.5-2.5% | 1.5-1.75% | 1.8-3.1% | 1.8-3.1% |
| antiozonant | 1.5-2.5% | 1.5-1.75% | 1.8-3.1% | 1.8-3.1% |
| water | 15-20% | 15-20% | ~0% | ~0% |

As is evident from Table 2, the final tire composition 14 (which can be the elastomeric matrix 50) differs from the initial rubber mixture upon removal of the water constituent. According to some implementations, the tire composition 14 can have guayule-derived natural rubber at 55-65%, 55-61%, and all ranges between these values (by weight of the tire composition). For example, the tire composition can include guayule-derived natural rubber at 55%, 56%, 57%, 58%, 59%, 60%, 61%, 62%, 63%, 64%, 65%, and all values between these values (by weight of the tire composition).

As is also evident from Table 2, according to some implementations, the final tire composition 14 (which can be the elastomeric matrix 50) can have flax seed material at 14-19%, 14-16.3%, 14-15%, and all ranges between these values (by weight of the tire composition). For example, the tire composition can include flax seed material at 14%, 14.5%, 15.0%, 15.5%, 16%, 16.5%, 17%, 17.5%, 18%, 18.5%, 19% and all values between these values (by weight of the tire composition).

As is further evident from Table 2, according to some implementations, the final tire composition 14 (which can be the elastomeric matrix 50) can have a metal oxide at 12-15%, 12-14%, and all ranges between these values (by weight of the tire composition). For example, the tire composition can include a metal oxide at 12%, 12.5%, 13.0%, 13.5%, 14%, 14.5%, 15%, and all values between these values (by weight of the tire composition).

As is also evident from Table 2, according to some implementations, the final tire composition 14 (which can be the elastomeric matrix 50) can have a carbon-based filler at 9-12%, 10-11%, and all ranges between these values (by weight of the tire composition). For example, the tire composition can include a carbon-based filler at 9%, 9.5%, 10%, 10.5%, 11%, 11.5%, 12%, and all values between these values (by weight of the tire composition).

As is further evident from Table 2, according to some implementations, the final tire composition 14 (which can be the elastomeric matrix 50) can have a metal oxide at 12-15%, 12-14%, and all ranges between these values (by weight of the tire composition). For example, the tire composition can include a metal oxide at 12%, 12.5%, 13.0%, 13.5%, 14%, 14.5%, 15%, and all values between these values (by weight of the tire composition).

As is additionally evident from Table 2, according to some implementations, the final tire composition 14 (which can be the elastomeric matrix 50) can have an antioxidant and/or an antiozonant, each at 1.8-3.1%, 2-2.9%, and all ranges between these values (by weight of the tire composition). For example, the tire composition can include one or both of an antioxidant and/or an antiozonant, each at 1.8%, 1.9%, 2%, 2.1%, 2.2%, 2.3%, 2.4%, 2.5%, 2.6%, 2.7%, 2.8%, 2.9%, 3%, 3.1%, and all values between these values (by weight of the tire composition).

The biodegradable tire 10 according to various aspects described herein provides many benefits compared to a traditional automotive tire. First, the biodegradable tire 10 is eco-friendly as the biodegradable tire composition 14 does not include any synthetic rubber. Another benefit of the biodegradable tire 10 is the airless construction, which cannot pop or puncture in the way that traditional pneumatic tires do. Moreover, the biodegradable tire 10 includes an estimated durability advantage of 2-3× years over a normal, pneumatic tire. The biodegradable tire 10 according to various aspects of the present disclosure may include an average deformation under a load of 1200 Newtons of only 0.00079721 mm across the entire structure. Even further, a deformation of only 0.00345 mm is predicted to occur on a portion of the biodegradable tire 10 that is in contact with a surface under normal, static compression. Therefore, the biodegradable tire 10 can provide excellent performance for a wide variety of applications.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connectors or other elements of the tire may be varied, or the nature or number of adjustment positions provided between the elements may be varied. It should be noted that the elements and/or assemblies of the tire may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further it is to be understood that such concepts are intended to be covered by the following claims unless these claims by their language expressly state otherwise.

Embodiment 1. A biodegradable tire composition includes (by weight of the tire composition) a flax seed material from 14% to 19%, a guayule-derived natural rubber derived from 55% to 65%, a metal oxide from 12% to 15%, a carbon-based filler from 9% to 12%, and one or both of an antioxidant and an antiozonant, each from 1.8% to 3.1%.

Embodiment 2. The tire composition of Embodiment 1 is provided, wherein the metal oxide is selected from the group consisting of ZnO, CaO, and combinations thereof.

Embodiment 3. The tire composition of Embodiment 2 is provided, wherein the carbon-based filler comprises sawdust.

Embodiment 4. The tire composition of Embodiment 3 is provided, wherein the one or both of an antioxidant and an antiozonant comprises or is derived from one or both of a phenylenediamine and a phenolic.

Embodiment 5. The tire composition of Embodiment 4 is provided, wherein the flax seed material is from 14% to 16.3%, the natural rubber is from 55% to 61%, the metal oxide is from 12% to 14%, and the carbon-based filler is from 10% to 11% (by weight of the tire composition).

Embodiment 6. A biodegradable tire includes an elastomeric matrix and a shape memory alloy scaffold integral with the elastomeric matrix. The elastomeric matrix includes (by weight of the elastomeric matrix) a flax seed material from 14% to 19%, a guayule-derived natural rubber from 55% to 65%, a metal oxide from 12% to 15%, a carbon-based filler from 9% to 12%, and one or both of an antioxidant and an antiozonant, each from 1.8% to 3.1%. Further, the tire is airless. In addition, the shape memory alloy scaffold comprises a Ni—Ti shape memory alloy, a Cu—Zn shape memory alloy, or a combination thereof.

Embodiment 7. The tire of Embodiment 6 is provided, wherein the shape memory alloy scaffold comprises a Ni—Ti shape memory alloy with 50% to 60% Ni (atomic weight %), a Cu—Zn shape memory alloy with 38.5% to 42% Zn (atomic weight %), or a combination thereof.

Embodiment 8. The tire of Embodiment 6 is provided, wherein the shape memory alloy scaffold comprises a Ni—Ti shape memory alloy with 57.5% to 58% Ni (atomic weight %), a Cu—Zn shape memory alloy with 40% to 40.5% Zn (atomic weight %), or a combination thereof.

Embodiment 9. The tire of Embodiment 8 is provided, wherein the metal oxide is selected from the group consisting of ZnO, CaO, and combinations thereof.

Embodiment 10. The tire of Embodiment 9 is provided, wherein the carbon-based filler comprises sawdust.

Embodiment 11. The tire of Embodiment 10 is provided, wherein the one or both of an antioxidant and an antiozonant comprises or is derived from one or both of a phenylenediamine and a phenolic.

Embodiment 12. The tire of Embodiment 11 is provided, wherein the flax seed material is from 14% to 16.3%, the natural rubber is from 55% to 61%, the metal oxide is from 12% to 14%, and the carbon-based filler is from 10% to 11% (by weight of the elastomeric matrix).

Embodiment 13. A biodegradable tire includes an elastomeric matrix and a shape memory alloy scaffold integral with the elastomeric matrix. The elastomeric matrix includes closed hexagonally-shaped cells. The shape memory alloy scaffold includes a helical structure. Further, the elastomeric matrix comprises (by weight of the elastomeric matrix) a flax seed material from 14% to 19%, a guayule-derived natural rubber from 55% to 65%, a metal oxide from 12% to 15%, a carbon-based filler from 9% to 12%, and one or both of an antioxidant and an antiozonant, each from 1.8% to 3.1%. Further, the tire is airless. In addition, the shape memory alloy scaffold comprises a Ni—Ti shape memory alloy, a Cu—Zn shape memory alloy, or a combination thereof.

Embodiment 14. The tire of Embodiment 13 is provided, wherein the hexagonally-shaped cells comprise walls having a thickness from 250 μm to 350 μm.

Embodiment 15. The tire of Embodiment 14 is provided, wherein the shape memory alloy scaffold comprises a Ni—Ti shape memory alloy with 50% to 60% Ni (atomic weight %), a Cu—Zn shape memory alloy with 38.5% to 42% Zn (atomic weight %), or a combination thereof.

Embodiment 16. The tire of Embodiment 14 is provided, wherein the shape memory alloy scaffold comprises a Ni—Ti shape memory alloy with 57.5% to 58% Ni (atomic weight %), a Cu—Zn shape memory alloy with 40% to 40.5% Zn (atomic weight %), or a combination thereof.

Embodiment 17. The tire of Embodiment 16 is provided, wherein the metal oxide is selected from the group consisting of ZnO, CaO, and combinations thereof

Embodiment 18. The tire of Embodiment 17 is provided, wherein the carbon-based filler comprises sawdust.

Embodiment 19. The tire of Embodiment 18 is provided, wherein the one or both of an antioxidant and an antiozonant comprises or is derived from one or both of a phenylenediamine and a phenolic.

Embodiment 20. The tire of Embodiment 19 is provided, wherein the flax seed material is from 14% to 16.3%, the natural rubber is from 55% to 61%, the metal oxide is from 12% to 14%, and the carbon-based filler is from 10% to 11% (by weight of the elastomeric matrix).

What is claimed is:

1. A biodegradable tire composition, comprising (by weight of the tire composition):
a flax seed material from 14% to 19%;
a guayule-derived natural rubber from 55% to 65%;
a metal oxide from 12% to 15%;
a carbon-based filler from 9% to 12%; and
one or both of an antioxidant and an antiozonant, each from 1.8% to 3.1%.

2. The tire composition of claim 1, wherein the metal oxide is selected from the group consisting of ZnO, CaO, and combinations thereof.

3. The tire composition of claim 2, wherein the carbon-based filler comprises sawdust.

4. The tire composition of claim 3, wherein the one or both of an antioxidant and an antiozonant comprises or is derived from one or both of a phenylenediamine and a phenolic.

5. The tire composition of claim 4, wherein the flax seed material is from 14% to 16.3%, the natural rubber is from 55% to 61%, the metal oxide is from 12% to 14%, and the carbon-based filler is from 10% to 11% (by weight of the tire composition).

6. A biodegradable tire, comprising:
an elastomeric matrix; and
a shape memory alloy scaffold integral with the elastomeric matrix,
wherein the elastomeric matrix comprises (by weight of the elastomeric matrix):
a flax seed material from 14% to 19%;
a guayule-derived natural rubber from 55% to 65%;
a metal oxide from 12% to 15%;
a carbon-based filler from 9% to 12%; and
one or both of an antioxidant and an antiozonant, each from 1.8% to 3.1%,
wherein the tire is airless, and
further wherein the shape memory alloy scaffold comprises a Ni—Ti shape memory alloy, a Cu—Zn shape memory alloy, or a combination thereof.

7. The tire of claim 6, wherein the shape memory alloy scaffold comprises a Ni—Ti shape memory alloy with 50% to 60% Ni (atomic weight %), a Cu—Zn shape memory alloy with 38.5% to 42% Zn (atomic weight %), or a combination thereof.

8. The tire of claim 6, wherein the shape memory alloy scaffold comprises a Ni—Ti shape memory alloy with 57.5% to 58% Ni (atomic weight %), a Cu—Zn shape memory alloy with 40% to 40.5% Zn (atomic weight %), or a combination thereof.

9. The tire of claim 8, wherein the metal oxide is selected from the group consisting of ZnO, CaO, and combinations thereof.

10. The tire of claim 9, wherein the carbon-based filler comprises sawdust.

11. The tire of claim 10, wherein the one or both of an antioxidant and an antiozonant comprises or is derived from one or both of a phenylenediamine and a phenolic.

12. The tire of claim 11, wherein the flax seed material is from 14% to 16.3%, the natural rubber is from 55% to 61%, the metal oxide is from 12% to 14%, and the carbon-based filler is from 10% to 11% (by weight of the elastomeric matrix).

13. A biodegradable tire, comprising:
an elastomeric matrix, wherein the elastomeric matrix comprises closed hexagonally-shaped cells; and
a shape memory alloy scaffold, wherein the shape memory alloy scaffold comprises a helical structure and is integral with the elastomeric matrix,
wherein the elastomeric matrix comprises (by weight of the elastomeric matrix):
a flax seed material from 14% to 19%;
a guayule-derived natural rubber derived from 55% to 65%;
a metal oxide from 12% to 15%;
a carbon-based filler from 9% to 12%; and
one or both of an antioxidant and an antiozonant, each from 1.8% to 3.1%,
wherein the tire is airless, and
further wherein the shape memory alloy scaffold comprises a Ni—Ti shape memory alloy, a Cu—Zn shape memory alloy, or a combination thereof.

14. The tire of claim 13, wherein the hexagonally-shaped cells comprise walls having a thickness from 250 μm to 350 μm.

15. The tire of claim 14, wherein the shape memory alloy scaffold comprises a Ni—Ti shape memory alloy with 50% to 60% Ni (atomic weight %), a Cu—Zn shape memory alloy with 38.5% to 42% Zn (atomic weight %), or a combination thereof.

16. The tire of claim 14, wherein the shape memory alloy scaffold comprises a Ni—Ti shape memory alloy with 57.5% to 58% Ni (atomic weight %), a Cu—Zn shape memory alloy with 40% to 40.5% Zn (atomic weight %), or a combination thereof.

17. The tire of claim 16, wherein the metal oxide is selected from the group consisting of ZnO, CaO, and combinations thereof.

18. The tire of claim 17, wherein the carbon-based filler comprises sawdust.

19. The tire of claim 18, wherein the one or both of an antioxidant and an antiozonant comprises or is derived from one or both of a phenylenediamine and a phenolic.

20. The tire of claim 19, wherein the flax seed material is from 14% to 16.3%, the natural rubber is from 55% to 61%, the metal oxide is from 12% to 14%, and the carbon-based filler is from 10% to 11% (by weight of the elastomeric matrix).
